(19) United States
(12) Patent Application Publication
(10) Pub. No.: US 2012/0301744 A1
(43) Pub. Date: Nov. 29, 2012

(54) ELECTRICAL STEEL SHEET PROVIDED WITH INSULATING COATING WHICH HAS INORGANIC WITH SOME ORGANIC MATERIALS

(75) Inventors: Kazumichi Sashi, Chiba (JP); Hiroyuki Ogata, Chiba (JP); Chiyoko Tada, Chiba (JP); Nobuko Nakagawa, Chiba (JP); Nobue Fujibayashi, Chiba (JP); Tomofumi Shigekuni, Chiba (JP); Kenichi Sasaki, Chiba (JP)

(73) Assignee: JFE Steel Corporation, Tokyo (JP)

(21) Appl. No.: 13/505,354

(22) PCT Filed: Nov. 5, 2010
(86) PCT No.: PCT/JP2010/070166

§ 371 Date: Aug. 14, 2012

(30) Foreign Application Priority Data
Nov. 5, 2009 (JP) 2009-254271

(51) Int. Cl. B32B 15/08

(52) U.S. Cl. 428/626

(57) ABSTRACT

An electrical steel sheet is provided with an insulating coating which has inorganic with some organic materials, the insulating coating including inorganic components and an organic resin, the insulating coating contains, as the inorganic components, a Zr compound, a B compound, and a Si compound, specifically, when expressed as percentages in the dry coating, 20% to 70% by mass of the Zr compound (in terms of ZrO₂), 0.1% to 5% by mass of the B compound (in terms of B₂O₃), and 10% to 50% by mass of the Si compound (in terms of SiO₂), and the balance containing the organic resin.

### RELATED APPLICATIONS

This is a §371 of International Application No. PCT/JP2010/070166, with an inter-national filing date of Nov. 5, 2010, which is based on Japanese Patent Application No. 2009-254271, filed Nov. 5, 2009, the subject matter of which is incorporated by reference.

### TECHNICAL FIELD

This disclosure relates to an electrical steel sheet provided with an insulating coating which has inorganic with some organic materials. More particularly, the disclosure relates to an electrical steel sheet provided with an insulating coating which has inorganic with some organic materials, in which corrosion resistance and water resistance are not degraded even without containing a chromium compound, and which has excellent powdering resistance, scratch resistance, sticking property (sticking resistance), TIG weldability, and punchability and, moreover, has excellent uniformity in the appearance of the coating after annealing.

### BACKGROUND

Insulating coatings for electrical steel sheets used in motors, transformers and the like are required to have, in addition to interlaminar insulation resistance, various characteristics such as convenience during processing and forming, and stability during storage and use. Since electrical steel sheets are used in a huge variety of applications, various insulating coatings have been developed in accordance with the intended applications. When electrical steel sheets are subjected to punching, shearing, bending, or the like, the magnetic properties of the electrical steel sheets are degraded by residual strain. Stress relief annealing is performed at a temperature of about 700° C. to 800° C. in many cases to deal with this problem. Consequently, in such cases, insulating coatings must be capable of withstanding stress relief annealing.

Insulating coatings can be classified broadly into three types: (1) an inorganic coating which emphasizes weldability and heat resistance and withstands stress relief annealing, (2) a resin-containing inorganic coating (i.e., coating which has inorganic with some organic materials) which aims to have both punchability and weldability, and withstands stress relief annealing, and (3) an organic coating which is used for special applications and cannot be subjected to stress relief annealing. Among these, the general-purpose ones which can withstand stress relief annealing are the coatings containing an inorganic component described in (1) and (2), both of which contain a chromium compound.

In particular, a chromate-based insulating coating of type (2) produced using a one-coating-one-baking method can significantly improve punchability compared with an inorganic insulating coating and, therefore, is widely used. For example, Japanese Examined Patent Application Publication No. 60-36476 describes an electrical steel sheet having an electrically insulating coating obtained by applying a coating liquid onto the surface of a base electrical steel sheet, followed by baking by an ordinary method, the coating liquid being prepared by mixing a bichromate aqueous solution containing at least one kind of bivalent metal with 5 to 120 parts by weight (as resin solid content) of a resin emulsion, as an organic resin, in which the vinyl acetate/VeoVa ratio is 90/10 to 40/60, and 10 to 60 parts by weight of an organic reducing agent, relative to 100 parts by weight of CrO₃ in the aqueous solution.

However, recently, due to the increased environmental awareness, products having an insulating coating which does not contain a chromium compound have also been desired by users and the like in the electrical steel sheet field.

Accordingly, electrical steel sheets provided with an insulating coating which does not contain a chromium compound have been developed. For example, Japanese Unexamined Patent Application Publication No. 10-130858 describes, as a chromium-free insulating coating having good punchability, an insulating coating obtained using a coating liquid composed of a resin and colloidal silica (alumina-containing silica). Furthermore, Japanese Unexamined Patent Application Publication No. 10-46350 describes an insulating coating obtained using a coating liquid including one or two or more of colloidal silica, alumina sol, and zirconia sol, and containing a water-soluble or emulsion resin. Furthermore, Japanese Patent No. 2944849 describes a chromium-free insulating coating mainly composed of a phosphate and containing a resin.

However, in these electrical steel sheets provided with an insulating coating which does not contain a chromium compound, bonding between inorganic substances is relatively weak and corrosion resistance is poor compared with those where a chromium compound is incorporated, which is a problem. Furthermore, in the case where back tension is applied by rubbing the surface of the steel sheet with felt in slitting (use of a tension pad), powdering of the surface coating may occur, causing a problem. Furthermore, after stress relief annealing, the coating weakens and scratches of the surface easily occur, which is also a problem.

For example, even when one or two or more of colloidal silica, alumina sol, and zirconia sol are simply used in the method described in JP '350, the problems described above cannot be solved. Furthermore, thorough studies have not been conducted regarding the case where the components are used in combination and mixed in specific amounts. Furthermore, in a phosphate coating having a chromium-free composition such as the one described in JP '849, the coating may become sticky, and water resistance tends to be degraded. Such a problem in JP '849 is likely to occur when the coating is baking at a relatively low temperature of 300° C. or lower and, in particular, such a problem noticeably occurs at 200° C. or lower. On the other hand, the baking temperature should be set as low as possible from the standpoint of reducing energy consumption and production cost and the like.

Furthermore, Japanese Unexamined Patent Application Publication Nos. 2007-197820 and 2007-197824 each disclose a coating composed of a polysiloxane polymer obtained by copolymerizing polysiloxane with any of various organic resins and, optionally, an inorganic compound such as silica or silicate. However, in the method described in JP '820 or JP '824, blowholes may occur during TIG welding, and a mottled pattern may be formed after annealing depending on the type of steel, which is a problem.

### SUMMARY

We discovered that the above-mentioned problems can be advantageously addressed by incorporating a Zr compound, a B compound, and a Si compound in combination as inorganic components in a coating which has inorganic with some organic materials.

We thus provide:
(1) An electrical steel sheet provided with an insulating coating which has inorganic with some organic materials, the insulating coating being disposed on a surface of the electrical steel sheet and including inorganic components and an organic resin, characterized in that the insulating coating contains, as the inorganic components, a Zr compound, a B compound, and a Si compound, specifically, when expressed as percentages in the dry coating, 20% to 70% by mass of the Zr compound (in terms of ZrO₂), 0.1% to 5% by mass of the B compound (in terms of B₂O₃), and 10% to 50% by mass of the Si compound (in terms of SiO₂), and the balance containing the organic resin.
(2) The electrical steel sheet provided with an insulating coating which has inorganic with some organic materials according to (1), characterized in that the coating further contains, when expressed as percentage in the dry coating, 30% by mass or less of one or two or more selected from a nitric compound (in terms of NO₃), a silane coupling agent (in terms of solid content), and a phosphorus compound (in terms of P₂O₅).
(3) The electrical steel sheet provided with an insulating coating which has inorganic with some organic materials according to (1) or (2), characterized in that the content of the organic resin in the coating is 5% to 40% by mass, when expressed as percentage in the dry coating.

It is thus possible to obtain an electrical steel sheet provided with an insulating coating which has inorganic with some organic materials, which has excellent characteristics such as powdering resistance, scratch resistance, sticking property, TIG weldability, and punchability, in which water resistance and corrosion resistance are not degraded even without the presence of a chromium compound and, moreover, which has excellent uniformity in the appearance of the coating after annealing.

### BRIEF DESCRIPTION OF THE DRAWINGS

FIG. 1 contains photographs which comparatively show the appearance of coatings after stress relief annealing.

### DETAILED DESCRIPTION

Our electrical steel sheets will be specifically described below.

First, the reasons for limiting the Zr compound, the B compound, and the Si compound, as the inorganic components in the coating which has inorganic with some organic materials, to the composition ranges described above will be described.

Note that the percent by mass of each of these components is the percentage relative to the total amount of the dry coating.
Zr compound: 20% to 70% by mass in terms of ZrO₂

Examples of the Zr compound include zirconium acetate, zirconium propionate, zirconium oxychloride, zirconium nitrate, ammonium zirconium carbonate, potassium zirconium carbonate, zirconium hydroxychloride, zirconium sulfate, zirconium phosphate, sodium zirconium phosphate, potassium zirconium hexafluoride, zirconium N-propoxide, zirconium N-butoxide, zirconium tetraacetylacetonate, zirconium tributoxyacetylacetonate, and zirconium tributoxystearate. Of course, these can be used alone or in combination of two or more. It is particularly preferable to use at least one of ammonium zirconium carbonate, potassium zirconium carbonate, and zirconium acetate from the standpoint of corrosion resistance and powdering resistance.

Such a Zr compound has a strong bonding force to oxygen, and can strongly bind to oxides, hydroxides, and the like on the surface of Fe. Furthermore, since the Zr compound has three or more bonds, by forming a network of Zr atoms or with another inorganic compound, it is possible to form a tough coating without using chromium. However, when the percentage in the dry coating of the Zr compound (in terms of ZrO₂) is less than 20% by mass, adhesion degrades, corrosion resistance and powdering resistance also degrade, and degradation in the appearance after annealing is caused by the Si compound. On the other hand, when the percentage exceeds 70% by mass, corrosion resistance and powdering resistance degrade, and the scratch resistance on the steel sheet subjected to stress relief annealing also degrades. Therefore, the content of the Zr compound (in terms of ZrO₂) is 20% to 70% by mass. The lower limit is more preferably 30% by mass, and the upper limit is more preferably 50% by mass.

In this description, “in terms of ZrO₂” means that the content of ZrO₂ is calculated assuming that all Zr contained forms ZrO₂. After being applied and dried (baked) onto a steel sheet, Zr compounds integrate into a network, and it is difficult to identify the individual compounds. Therefore, such a conversion is convenient. The same applies to some other compounds, and the content of each compound is calculated by conversion into a specified oxide. B compound: 0.1% to 5% by mass in terms of B₂O₃

Examples of the B compound include boric acid, orthoboric acid, metaboric acid, tetraboric acid, sodium metaborate, and sodium tetraborate. These can be used alone or in combination. The B compound is, however, not limited thereto. For example, a compound that dissolves in water to generate borate ions may be used. Furthermore, borate ions may be linearly or cyclically polymerized.

Such a B compound advantageously contributes to solving the problems caused in the case where the Zr compound is added alone. That is, in the case where the Zr compound is added alone, corrosion resistance and powdering resistance degrade, and the scratch resistance in the sheet subjected to stress relief annealing tends to significantly degrade. The reason for this is believed to be that in the case where the Zr compound is used alone, since the volume contraction during baking is large, cracking of coating easily occurs, resulting in partial exposure of the base.

In contrast, by mixing an appropriate amount of the B compound with the Zr compound, cracking of the coating which occurs in the case of Zr alone is effectively reduced, and powdering resistance can be markedly improved.

In this case, when the percentage in the dry coating of the B compound (in terms of B₂O₃) is less than 0.1% by mass, the effect of addition thereof may be insufficient. On the other hand, when the percentage in the dry coating of the B compound exceeds 5% by mass, the unreacted substance (unreacted B compound) in the coating remains, and the problem of fusion between coatings (sticking) may occur after stress relief annealing. Therefore, the content of the B compound (in terms of B₂O₃) is 0.1% to 5% by mass.

The lower limit is more preferably 0.5%, and the upper limit is more preferably 3%.

In addition, incorporation of at least one of boric acid, orthoboric acid, metaboric acid, and tetraboric acid is preferable in view of corrosion resistance. Si compound: 10% to 50% by mass in terms of SiO₂

Examples of the Si compound include colloidal silica, fumed silica, alkoxysilanes, and siloxanes. However, the Si compound is not limited thereto. For example, Si oxides other than the above-mentioned materials can be suitably used. Of course, the Si compounds can be used alone or in combination.

As in the B compound, the Si compound is useful in solving the problems caused in the case where the Zr compound is used alone. That is, in the case where the Zr compound is used alone, corrosion resistance and powdering resistance degrade, and the scratch resistance in the sheet subjected to stress relief annealing tends to significantly degrade. By mixing an appropriate amount of the Si compound, powdering resistance can be markedly improved.

In this case, when the percentage in the dry coating of the Si compound (in terms of SiO₂) is less than 10% by mass, sufficient corrosion resistance cannot be obtained. On the other hand, when the percentage in the dry coating of the Si compound exceeds 50% by mass, powdering resistance degrades, and the scratch resistance in the sheet subjected to stress relief annealing degrades. Therefore, the content of the Si compound is 10% to 50% by mass.

The lower limit is more preferably 15%, and the upper limit is more preferably 40%.

Furthermore, in addition to the three components described above, one or two or more selected from a nitric compound, a silane coupling agent, and a phosphorus compound can be incorporated in the total amount of 30% by mass or less, when expressed as percentage in the dry coating. Note that the percentages in the dry coating of the nitric compound, the silane coupling agent, and the phosphorus compound are in terms of NO₃ (nitric compound), in terms of solid content (silane coupling agent), and in terms of P₂O₅ (phosphorus compound), respectively. The nitric compound, the silane coupling agent, and the phosphorus compound contribute to improvement in corrosion resistance and scratch resistance. However, when the percentage in the dry coating exceeds 30% by mass, unreacted substances remain in the coating, resulting in degradation in water resistance. Therefore, the content is preferably set at 30% by mass or less. The total content is preferably 1% by mass or more, when expressed as percentage in the dry coating to fully exert the effect of these components.

Furthermore, it is preferable to incorporate at least a silane coupling agent and/or a phosphorus compound in the total amount of 5% or more in view of powdering resistance.

As the nitric compound, the nitric acid series and nitrous acid series described below are advantageously suitable:

### Nitric Acid Series

Nitric acid (HNO₃), potassium nitrate (KNO₃), sodium nitrate (NaNO₃), ammonium nitrate (NH₄NO₃), calcium nitrate (Ca(NO₃)₂), silver nitrate (AgNO₃), iron nitrate(II) (Fe(NO₃)₂), iron nitrate(III) (Fe(NO₃)₃), copper nitrate(II) (Cu(NO₃)₂), barium nitrate (Ba(NO₃)₂), aluminum nitrate (Al(NO₃)₃), magnesium nitrate (Mg(NO₃)₂), zinc nitrate (Zn(NO₃)₂), nickel nitrate(II) (Ni(NO₃)₂), zirconium nitrate (ZrO(NO₃)₂)

### Nitrous Acid Series

Nitrous acid (HNO₂), potassium nitrite (KNO₂), calcium nitrite (Ca(NO₂)₂), silver nitrite (AgNO₂), sodium nitrite (NaNO₂), barium nitrite (Ba(NO₂)₂), ethyl nitrite, isoamyl nitrite, isobutyl nitrite, isopropyl nitrite, tert-butyl nitrite, n-butyl nitrite, n-propyl nitrite

Of course, the nitric compounds can be used alone or in combination. Furthermore, incorporation of at least one of nitric acid and nitrous acid is preferable in view of corrosion resistance.

Furthermore, as the silane coupling agent, the silane coupling agents described below are advantageously suitable:

### Vinyl-Based

Vinyltrichlorosilane, vinyltrimethoxysilane, vinyltriethoxysilane

### Epoxy-Based

2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane

### Styryl-Based

p-Styryltrimethoxysilane

### Methacryloxy-Based

3-Methacyloxypropylmethyldimethoxysilane, 3-methacryloxypropyltrimethoxysilane, 3-methacyloxypropylmethyldiethoxysilane, 3-methacryloxypropyltriethoxysilane

### Acryloxy-Based

3-Acryloxypropyltrimethoxysilane

### Amino-Based

N-2-(aminoethyl)-3-aminopropylmethyldimethoxysilane, N-2-(aminoethyl)-3-aminopro-pyltrimethoxysilane, N-2-(aminoethyl)-3-aminopropyltriethoxysilane, 3-aminopropyltri-methoxysilane, 3-aminopropyltriethoxysilane, 3-triethoxysilyl-N-(1,3-dimethyl-butyl-idene)propylamine and partial hydrolysates thereof, N-phenyl-3-aminopropyltrimethoxy-silane, hydrochlorides of N-(vinylbenzyl)-2-aminoethyl-3-aminopropyltrimethoxysilane, special aminosilanes

### Ureide-Based

3-Ureidepropyltriethoxysilane

### Chloropropyl-Based

3-Chloropropyltrimethoxysilane

### Mercapto-Based

3-Mercaptopropylmethyldimethoxysilane, 3-mercaptopropyltrimethoxysilane

### Polysulfide-Based

Bis(triethoxysilylpropyl)tetrasulfide

### Isocyanate-Based

3-Isocyanatepropyltriethoxysilane

Of course, the silane coupling agents can be used alone or in combination. Furthermore, incorporation of at least one of vinyltrimethoxysilane, 3-glycidoxypropyltriethoxysilane, and N-2-(aminoethyl)-3-aminopropyltrimethoxysilane is preferable in view of powdering resistance.

Furthermore, as the phosphorus compound, the phosphoric acids and phosphates described below are advantageously suitable:

### Phosphoric Acid

Orthophosphoric acid, anhydrous phosphoric acid, straight-chain polyphosphoric acid, cyclic metaphosphoric acid

### Phosphate

Magnesium phosphate, aluminum phosphate, calcium phosphate, zinc phosphate, ammonium phosphate

Of course, the phosphorus compounds can be used alone or in combination. Furthermore, incorporation of at least one of orthophosphoric acid, anhydrous phosphoric acid, straight-chain polyphosphoric acid, and ammonium phosphate is preferable in view of powdering resistance.

Furthermore, Hf, HfO₂, TiO₂, Fe₂O₃, and the like, as impurities, may be mixed into the inorganic components. If the total amount of the impurities is 1% by mass or less in the dry coating, problems do not particularly occur.

The coating is composed of the inorganic components described above and an organic resin. Preferably, 5% to 40% by mass of the organic resin is mixed, when expressed as a percentage, in the dry coating.

The organic resin is not particularly limited and any known organic resin conventionally used is advantageously suitable. Examples thereof include aqueous resins (which form emulsions or dispersions or which are water-soluble) such as an acrylic resin, an alkyd resin, a polyolefin resin, a styrene resin, a vinyl acetate resin, an epoxy resin, a phenolic resin, a polyester resin, a urethane resin, and a melamine resin. An emulsion of an acrylic resin or ethylene-acrylic acid resin is particularly preferable. Of course, the organic resins can be used alone or in combination.

Such an organic resin contributes to improvement in corrosion resistance, scratch resistance, and punchability. When the percentage in the dry coating is 5% by mass or more, the effect of addition thereof is large. On the other hand, when the percentage in the dry coating is 40% by mass or less, the scratch resistance after stress relief annealing does not degrade. Therefore, the content of the organic resin is preferably about 5% to 40% by mass, and more preferably 10% to 40% by mass, when expressed as a percentage in the dry coating.

Note that the percentages in the dry coating correspond to the contents of the respective components in the coating formed on the surface of the steel sheet. It is also possible to determine the percentages in the dry coating on the basis of the dried residual (solid content) after the coating liquid for forming the coating onto the steel sheet has been dried at 180° C. for 30 minutes. Regarding the organic resin, the percentage can be determined by measuring the C amount. Of course, the percentages in the dry coating may be partially or fully estimated from the amounts of solid contents added to the coating liquid.

Furthermore, besides the components described above, our insulating coating does not prevent optional incorporation of commonly used (i.e., known) additives or another inorganic compound or organic compound. As the organic compound, an organic acid may be incorporated as a contact inhibitor between the inorganic components and the organic resin. As the organic acid, for example, an acrylic acid-containing polymer or copolymer may be mentioned. Additives may be added to further improve the properties and uniformity of the insulating coating, and examples thereof include a surfactant, a rust-preventive agent, a lubricant, and an antioxidant. The amount of addition of such additives is preferably set at about 10% by mass or less, when expressed as a percentage in the dry coating, from the standpoint of maintaining satisfactory coating characteristics.

The electrical steel sheet as the base material is not particularly limited, and any conventionally known one may be suitably used.

That is, any one of the so-called “mild steel sheet” (sheet iron) having high magnetic induction, a general-purpose cold rolled steel sheet, such as SPCC, and a non-oriented electrical steel sheet incorporated with Si and Al to increase resistivity is advantageously suitable. The typical composition (% by mass, mass ppm) of a non-oriented electrical steel sheet incorporated with Si and Al to increase resistivity includes 5 to 500 ppm of C, 0.1% to 7% of Si, 0.05% to 1.0% of Mn, 1.5% or less of Al, 0.1% or less of P, and impurity elements, such as N, S, and O. As necessary, Ti, Nb, Sn, and the like may be incorporated in the total amount of about 0.1% or less.

A method of forming an insulating coating will now be described.

Pretreatment for an electrical steel sheet as the base material is not particularly specified. That is, although the electrical steel sheet may be untreated, it is advantageous to subject the electrical steel sheet to cleaning with an alkali or the like and acid pickling with hydrochloric acid, sulfuric acid, phosphoric acid, or the like.

Then, by applying a coating liquid which is prepared by mixing, at a predetermined ratio, a Zr compound, a B compound, a Si compound, optionally a phosphorus compound, and as necessary, additives and the like with an organic resin, onto a surface of the electrical steel sheet, followed by baking, an insulating coating is formed. As an application method for the coating liquid for insulating coating, any of the methods generally used in the industry, such as a method using a roll coater, a flow coater, spraying, a knife coater, or the like, can be used. Furthermore, as a baking method, a commonly used method, such as hot-air, infrared, or induction heating, can be used. The baking temperature may be at an ordinary level as long as the temperature of the steel sheet becomes about 150° C. to 350° C. Baking is possible without a problem even if the baking temperature is about 300° C. or lower.

The electrical steel sheet provided with the insulating coating can be subjected to stress relief annealing. Thereby, for example, it is possible to remove residual stress due to punching. As a preferable atmosphere for stress relief annealing, a N₂ atmosphere, a DX gas atmosphere, or the like in which iron is not easily oxidized is used. In this case, by setting the dew point to be high, for example, Dp: about 5° C. to 60° C. and by slightly oxidizing the surface and the cut end face, corrosion resistance can be further improved. The stress relief annealing temperature is preferably 700° C. to 900° C., and more preferably 700° C. to 800° C. The holding time at the stress relief annealing temperature is preferably long, and more preferably one hour or more. The preferable upper limit is about 10 hours.

The coating weight of the insulating coating is not particularly limited, but is preferably about 0.05 to 5 g/m² per one surface. The coating weight, i.e., the total solid mass of the insulating coating can be determined from the weight loss after removing the coating in alkali solution. Furthermore, in the case where the coating weight is small, the coating weight determination is possible from the calibration curve of X-ray fluorescence and the alkali removal method. When the coating weight is set at 0.05 g/m² or more, it is possible to satisfy corrosion resistance and an insulating property. When the coating weight is set at 5 g/m² or less, adhesion improves and degradation in coatability such as formation of blisters during coating-baking, does not occur. The coating weight is more preferably 0.1 to 3.0 g/m². The insulating coating is preferably provided on both surfaces of the steel sheet. However, the insulating coating may be provided on one surface depending on the purpose. Furthermore, depending on the purpose, one surface only is provided with the insulating coating, and the other surface may be provided with another insulating coating.

### EXAMPLES

### Example 1

The advantageous effects will be specifically described below on the basis of examples. However, it is to be understood that this disclosure is not limited to the examples.

The Zr compound, the B compound, and the Si compound and, optionally, additives such as the nitric compound, the silane coupling agent, and the phosphorus compound, together with the organic resin were added to deionized water such that the components of the insulating coating after drying had the contents shown in Table 1-1 or 1-2 to prepare each coating liquid. The solid content concentration of the total of the components relative to the amount of deionized water was set at 50 g/l.

The coating liquids were each applied with a roll coater onto a surface of a specimen obtained by cutting out of an electrical steel sheet with a thickness of 0.5 mm [50A230 (JIS C 2552(2000))] into a size of 150 mm in width and 300 mm in length. Subsequently, baking was performed in a hot-air baking oven at the baking temperature (temperature of steel sheet) shown in Table 1-1 or 1-2, and then the specimen was left to stand to cool to room temperature, thereby forming an insulating coating.

Regarding thus obtained electrical steel sheets provided with an insulating coating which has inorganic with some organic materials, the corrosion resistance, powdering resistance, punchability, TIG weldability, scratch resistance after stress relief annealing in a nitrogen atmosphere at 750° C. for two hours, appearance after the stress relief annealing, and sticking property were examined. The results thereof are shown in Table 2.

Note that Table 3 shows the kind of the Zr compound, Table 4 shows the kind of the B compound, Table 5 shows the kind of the Si compound, Table 6 shows the kinds of the phosphorus compound and the nitric compound, Table 7 shows the kind of the organic resin, and Table 8 shows the kind of the silane coupling agent.

Furthermore, methods for evaluating characteristics are as described below. Corrosion resistance

A humidity cabinet test (50° C., relative humidity 98%) was performed on the test specimens. The red rust occurrence ratio after 48 hours was visually observed, and evaluated in terms of area ratio.

### Evaluation Criteria

A: Red rust area ratio less than 20%
B: Red rust area ratio 20% or more and less than 40%
C: Red rust area ratio 40% or more and less than 60%
D: Red rust area ratio 60% or more

### Powdering Resistance

Testing conditions: with a felt being pressed against the surface (one surface) of the coating of a specimen at a contact surface width of 20 mm×10 mm and a load of 0.4 MPa (3.8 kg/cm²), a simple reciprocating motion was applied 100 times to the specimen. Rubbing traces after testing were visually observed, and the peeling state and powdering state of the coating were evaluated.

### Evaluation Criteria

A: Substantially no rubbing traces are observed.
B: Rubbing traces and powdering are slightly observed.
C: Peeling of the coating proceeds to such an extent that rubbing traces and powdering are clearly recognized.
D: Peeling occurs such that the base steel sheet is exposed and a huge amount of dust is generated.

### Scratch Resistance After Annealing

Testing conditions: the surface of a sample annealed while being held in a nitrogen (N₂) atmosphere at 750° C. for two hours was scratched by an edged portion obtained by shearing the same steel sheet as the sample, degrees of scratches and powdering were evaluated.

### Evaluation Criteria

A: Substantially no occurrence of scratches and powdering is observed.
B: Rubbing traces and powdering are slightly observed.
C: Rubbing traces and powdering are clearly recognized.
D: scraping occurs such that the base steel sheet is exposed and a huge amount of dust powder is generated.

### Sticking Resistance

Ten 50-mm square test specimens were laminated and subjected to annealing, while under an applied load of 20 kPa (200 g/cm²), in a nitrogen atmosphere, under conditions of 750° C. for two hours. Next, a 500-g weight was made to fall onto the test specimens (steel sheets), and the free fall drop height at which the test specimens were divided into five pieces was checked.

### Evaluation Criteria

A: 10 cm or less
B: More than 10 cm and 15 cm or less
C: More than 15 cm and 30 cm or less
D: More than 30 cm

### Punchability

Using a 15 mmφ steel die, a test specimen was punched until the burr height reached 50 μm, and the number of punching strokes was evaluated.

### Evaluation Criteria

A: 1,000,000 or more
B: 500,000 or more and less than 1,000,000
C: 100,000 or more and less than 500,000
D: Less than 100,000

### TIG Weldability

Test specimens were stacked at a pressure of 9.8 MPa (100 kgf/cm²) so as to have a thickness of 30 mm, and the end face portion thereof (length 30 mm) was subjected to TIG welding under the following conditions:

Welding current: 120 A

Ar gas flow rate: 6 l/min

Welding speed: 10, 20, 30, 40, 50, 60, 70, 80, 90, 100 cm/min

### Evaluation Criteria

Evaluation was performed on the basis of the magnitude of the welding speed at which the number of blowholes was five or less per bead.
A: 60 cm/min or more
B: 40 cm/min or more and less than 60 cm/min
C: 20 cm/min or more and less than 40 cm/min
D: Less than 20 cm/min

### Water Resistance

A test specimen was exposed in boiling water vapor for 30 minutes, and a change in appearance was observed.

### Evaluation Criteria

A: No change
B: A slight change in color is visually observed.
C: A change in color is clearly visually observed.
D: Dissolution of coating

### Appearance After Stress Relief Annealing

A test specimen was held in a N₂ atmosphere at 750° C. for two hours and then cooled to normal temperature, and then the appearance of the steel sheet was visually observed.

### Evaluation Criteria

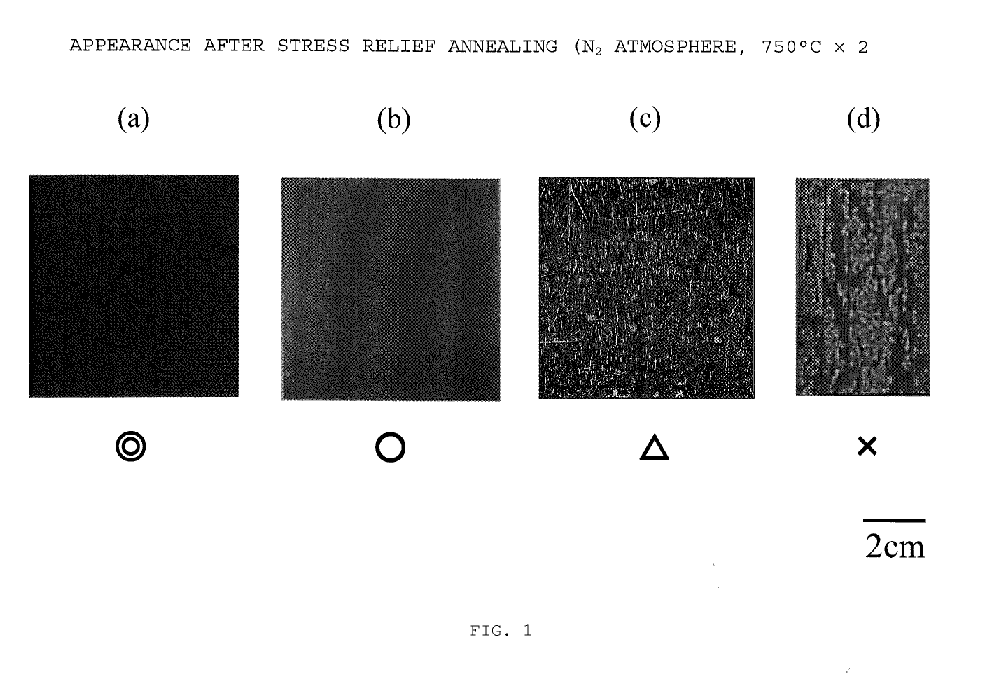

A: As shown in FIG. 1(a), the appearance after annealing is completely uniform.
B: As shown in FIG. 1(b), unevenness is observed in the appearance after annealing.
C: As shown in FIG. 1(c), a mottled pattern is observed in the appearance after annealing.
D: As shown in FIG. 1(d), a noticeable mottled pattern is observed in the appearance after annealing.

TABLE 1-1

| | Components of insulating coating | | | | | | | | | |
|---|---|---|---|---|---|---|---|---|---|---|
| | Inorganic components | | | | | | | | | |
| | Zr | | B | | Si | | Phosphorus | | Nitric | |
| | compound | | compound | | compound | | compound | | compound | |
| | | Amount | | Amount | | Amount | | Amount | | Amount |
| | | of | | of | | of | | of | | of |
| | | addition | | addition | | addition | | addition | | addition |
| | | (in terms | | (in terms | | (in terms | | (in terms | | (in terms |
| | Kind | of ZrO₂) | Kind | of B₂O₃) | Kind | of SiO₂) | Kind | of P₂O₅) | Kind | of NO₃) |
| No. | Table 3 | (mass %) | Table 4 | (mass %) | Table 5 | (mass %) | Table 6 | (mass %) | Table 6 | (mass %) |
| 1 | Z1 | 50 | B1 | 2 | S2 | 30 | — | 0 | — | 0 |
| 2 | Z1 | 20 | B1 | 2 | S2 | 50 | — | 0 | — | 0 |
| 3 | Z1 | 70 | B1 | 2 | S2 | 10 | — | 0 | — | 0 |
| 4 | Z1 | 50 | B1 | 0.1 | S2 | 30 | — | 0 | — | 0 |
| 5 | Z1 | 50 | B1 | 5 | S2 | 30 | — | 0 | — | 0 |
| 6 | Z1 | 50 | B1 | 2 | S2 | 10 | — | 0 | — | 0 |
| 7 | Z1 | 40 | B1 | 2 | S2 | 50 | — | 0 | — | 0 |
| 8 | Z2 | 50 | B1 | 2 | S2 | 30 | — | 0 | — | 0 |
| 9 | Z3 | 50 | B1 | 2 | S2 | 30 | — | 0 | — | 0 |
| 10 | Z4 | 50 | B1 | 2 | S2 | 30 | — | 0 | — | 0 |
| 11 | Z5 | 50 | B1 | 2 | S2 | 30 | — | 0 | — | 0 |
| 12 | Z6 | 50 | B1 | 2 | S2 | 30 | — | 0 | — | 0 |
| 13 | Z1 | 50 | B1 | 2 | S1 | 30 | — | 0 | — | 0 |
| 14 | Z1 | 50 | B1 | 2 | S3 | 30 | — | 0 | — | 0 |
| 15 | Z1 | 50 | B1 | 2 | S4 | 30 | — | 0 | — | 0 |
| 16 | Z1 | 40 | B1 | 2 | S2 | 20 | P1 | 30 | — | 0 |
| 17 | Z1 | 40 | B1 | 2 | S2 | 20 | P2 | 30 | — | 0 |
| 18 | Z1 | 40 | B1 | 2 | S2 | 20 | — | 0 | N1 | 30 |
| 19 | Z1 | 40 | B1 | 2 | S2 | 20 | — | 0 | N2 | 30 |
| 20 | Z1 | 40 | B1 | 2 | S2 | 20 | — | 0 | — | 0 |

| | Components of insulating coating | | | | | | |
|---|---|---|---|---|---|---|---|
| | Inorganic | | | | | | |
| | components | | | | | | |
| | Silane coupling | | | | | | |
| | agent | | | | | | |
| | | Amount | | | | | |
| | | of | | | | | |
| | | addition | Organic resin | | | Insulating | |
| | | (in terms | | Content | | coating | |
| | | of solid | | in dry | Baking | coating | |
| | Kind | content) | Kind | coating | temperature | weight | |
| No. | Table 8 | (mass %) | Table 7 | (mass %) | (° C.) | (g/m²) | Remarks |
| 1 | — | 0 | R1 | 18 | 250 | 0.5 | Ex. 1 |
| 2 | — | 0 | R1 | 28 | 250 | 0.3 | Ex. 2 |
| 3 | — | 0 | R1 | 18 | 250 | 0.4 | Ex. 3 |
| 4 | — | 0 | R1 | 19.9 | 250 | 0.6 | Ex. 4 |
| 5 | — | 0 | R1 | 15 | 250 | 0.2 | Ex. 5 |
| 6 | — | 0 | R1 | 38 | 250 | 0.5 | Ex. 6 |
| 7 | — | 0 | R1 | 8 | 250 | 0.5 | Ex. 7 |
| 8 | — | 0 | R1 | 18 | 250 | 0.5 | Ex. 8 |
| 9 | — | 0 | R1 | 18 | 250 | 0.5 | Ex. 9 |
| 10 | — | 0 | R1 | 18 | 250 | 0.5 | Ex. 10 |
| 11 | — | 0 | R1 | 18 | 250 | 0.5 | Ex. 11 |
| 12 | — | 0 | R1 | 18 | 250 | 0.5 | Ex. 12 |
| 13 | — | 0 | R1 | 18 | 250 | 0.5 | Ex. 13 |
| 14 | — | 0 | R1 | 18 | 250 | 0.5 | Ex. 14 |
| 15 | — | 0 | R1 | 18 | 250 | 0.5 | Ex. 15 |
| 16 | — | 0 | R1 | 8 | 250 | 0.5 | Ex. 16 |
| 17 | — | 0 | R1 | 8 | 250 | 0.5 | Ex. 17 |
| 18 | — | 0 | R1 | 8 | 250 | 0.5 | Ex. 18 |
| 19 | — | 0 | R1 | 8 | 250 | 0.5 | Ex. 19 |
| 20 | CI1 | 30 | R1 | 8 | 250 | 0.5 | Ex. 20 |

TABLE 1-2

| | Components of insulating coating | | | | | | | | | |
|---|---|---|---|---|---|---|---|---|---|---|
| | Inorganic components | | | | | | | | | |
| | Zr | | B | | Si | | Phosphorus | | Nitric | |
| | compound | | compound | | compound | | compound | | compound | |
| | | Amount | | Amount | | Amount | | Amount | | Amount |
| | | of | | of | | of | | of | | of |
| | | addition | | addition | | addition | | addition | | addition |
| | | (in terms | | (in terms | | (in terms | | (in terms | | (in terms |
| | Kind | of ZrO₂) | Kind | of B₂O₃) | Kind | of SiO₂) | Kind | of P₂O₅) | Kind | of NO₃) |
| No. | Table 3 | (mass %) | Table 4 | (mass %) | Table 5 | (mass %) | Table 6 | (mass %) | Table 6 | (mass %) |
| 21 | Z1 | 40 | B1 | 2 | S2 | 20 | — | 0 | — | 0 |
| 22 | Z1 | 40 | B1 | 2 | S2 | 20 | — | 0 | — | 0 |
| 23 | Z1 | 50 | B1 | 2 | S2 | 30 | — | 0 | — | 0 |
| 24 | Z1 | 50 | B1 | 2 | S2 | 30 | — | 0 | — | 0 |
| 25 | Z1 | 50 | B1 | 2 | S2 | 30 | — | 0 | — | 0 |
| 26 | Z1 | 50 | B1 | 2 | S2 | 30 | — | 0 | — | 0 |
| 27 | Z1 | 50 | B1 | 2 | S2 | 30 | — | 0 | — | 0 |
| 28 | Z1 | 30 | B1 | 2 | S2 | 10 | P1 | 15 | — | 0 |
| 29 | Z1 | 30 | B1 | 2 | S2 | 10 | P2 | 15 | — | 0 |
| 30 | Z1 | 30 | B1 | 2 | S2 | 10 | — | 0 | N1 | 15 |
| 31 | Z1 | 30 | B1 | 2 | S2 | 10 | — | 0 | N2 | 15 |
| 32 | Z1 | 30 | B1 | 2 | S2 | 10 | — | 0 | — | 0 |
| 33 | Z1 | 30 | B1 | 2 | S2 | 10 | — | 0 | — | 0 |
| 34 | Z1 | 30 | B1 | 2 | S2 | 10 | — | 0 | — | 0 |
| 35 | Z1 | 10 | B1 | 2 | S2 | 30 | — | 0 | — | 0 |
| 36 | Z1 | 80 | B1 | 2 | S2 | 10 | — | 0 | — | 0 |
| 37 | Z1 | 50 | B1 | 0.01 | S2 | 30 | — | 0 | — | 0 |
| 38 | Z1 | 50 | B1 | 10 | S2 | 30 | — | 0 | — | 0 |
| 39 | Z1 | 50 | B1 | 2 | S2 | 3 | — | 0 | — | 0 |
| 40 | Z1 | 30 | B1 | 2 | S2 | 60 | — | 0 | — | 0 |
| 41 | Z1 | 50 | B1 | 0.07 | S2 | 30 | — | 0 | — | 0 |
| 42 | Z1 | 50 | B1 | 7 | S2 | 30 | — | 0 | — | 0 |
| 43 | Z1 | 50 | B2 | 2 | S2 | 30 | — | 0 | — | 0 |
| 44 | Z1 | 40 | B2 | 2 | S2 | 25 | P1 | 5 | N1 | 5 |
| 45 | Z1, Z2 | 30, 20 | B2 | 2 | S2 | 30 | — | 0 | — | 0 |
| 46 | Z1 | 50 | B2 | 2 | S1, S2 | 10, 20 | — | 0 | — | 0 |
| 47 | Z1 | 50 | B2 | 2 | S2 | 30 | — | 0 | — | 0 |

| | Components of insulating coating | | | | | | |
|---|---|---|---|---|---|---|---|
| | Inorganic | | | | | | |
| | components | | | | | | |
| | Silane coupling | | | | | | |
| | agent | | | | | | |
| | | Amount | | | | | |
| | | of | | | | | |
| | | addition | Organic resin | | | Insulating | |
| | | (in terms | | Content | | coating | |
| | | of solid | | in dry | Baking | coating | |
| | Kind | content) | Kind | coating | temperature | weight | |
| No. | Table 8 | (mass %) | Table 7 | (mass %) | (° C.) | (g/m²) | Remarks |
| 21 | CI2 | 30 | R1 | 8 | 250 | 0.5 | Ex. 21 |
| 22 | CI3 | 30 | R1 | 8 | 250 | 0.5 | Ex. 22 |
| 23 | — | 0 | R1 | 18 | 250 | 0.03 | Ex. 23 |
| 24 | — | 0 | R1 | 18 | 250 | 5.0 | Ex. 24 |
| 25 | — | 0 | R2 | 18 | 250 | 0.5 | Ex. 25 |
| 26 | — | 0 | R3 | 18 | 250 | 0.5 | Ex. 26 |
| 27 | — | 0 | R4 | 18 | 250 | 0.5 | Ex. 27 |
| 28 | — | 0 | R1 | 8 | 250 | 0.5 | Ex. 28 |
| 29 | — | 0 | R1 | 8 | 250 | 0.5 | Ex. 29 |
| 30 | — | 0 | R1 | 8 | 250 | 0.5 | Ex. 30 |
| 31 | — | 0 | R1 | 8 | 250 | 0.5 | Ex. 31 |
| 32 | CI1 | 15 | R1 | 8 | 250 | 0.5 | Ex. 32 |
| 33 | CI2 | 15 | R1 | 8 | 250 | 0.5 | Ex. 33 |
| 34 | CI3 | 15 | R1 | 8 | 250 | 0.5 | Ex. 34 |
| 35 | — | 0 | R1 | 58 | 250 | 0.3 | Comp. Ex. 1 |
| 36 | — | 0 | R1 | 8 | 250 | 0.4 | Comp. Ex. 2 |
| 37 | — | 0 | R1 | 19.99 | 250 | 0.6 | Comp. Ex. 3 |
| 38 | — | 0 | R1 | 10 | 250 | 0.2 | Comp. Ex. 4 |
| 39 | — | 0 | R1 | 45 | 250 | 0.5 | Comp. Ex. 5 |
| 40 | — | 0 | R1 | 8 | 250 | 0.5 | Comp. Ex. 6 |
| 41 | — | 0 | R1 | 19.93 | 250 | 0.5 | Comp. Ex. 7 |
| 42 | — | 0 | R1 | 13 | 250 | 0.5 | Comp. Ex. 8 |
| 43 | — | 0 | R1 | 18 | 250 | 0.5 | Ex. 35 |
| 44 | CI1 | 5 | R1 | 18 | 250 | 0.5 | Ex. 36 |
| 45 | — | 0 | R1 | 18 | 250 | 0.5 | Ex. 37 |
| 46 | — | 0 | R1 | 18 | 250 | 0.5 | Ex. 38 |
| 47 | — | 0 | R1, R3 | 10, 8 | 250 | 0.5 | Ex. 39 |

TABLE 2

| | Characteristics of coating | | | | | | | | |
|---|---|---|---|---|---|---|---|---|---|
| | | | Scratch | | | | | | |
| | | | resistance | | | | | Appearance | |
| | Corrosion | Powdering | after | Sticking | TIG | | Water | after | |
| No. | resistance | resistance | annealing | property | weldability | Punchability | resistance | annealing | Remarks |
| 1 | A | A | A | A | A | A | A | A | Ex. 1 |
| 2 | B | B | B | A | A | A | A | B | Ex. 2 |
| 3 | B | B | B | A | A | A | A | A | Ex. 3 |
| 4 | B | B | B | A | A | A | A | A | Ex. 4 |
| 5 | A | A | A | B | A | A | A | A | Ex. 5 |
| 6 | B | A | A | A | A | A | A | A | Ex. 6 |
| 7 | A | B | B | A | A | A | A | A | Ex. 7 |
| 8 | A | A | A | A | A | A | A | A | Ex. 8 |
| 9 | A | A | A | A | A | A | A | A | Ex. 9 |
| 10 | A | A | A | A | A | A | A | A | Ex. 10 |
| 11 | A | A | A | A | A | A | A | A | Ex. 11 |
| 12 | A | A | A | A | A | A | A | A | Ex. 12 |
| 13 | A | A | A | A | A | A | A | A | Ex. 13 |
| 14 | A | A | A | A | A | A | A | A | Ex. 14 |
| 15 | A | A | A | A | A | A | A | A | Ex. 15 |
| 16 | A | A | A | A | A | A | B | A | Ex. 16 |
| 17 | A | A | A | A | A | A | B | A | Ex. 17 |
| 18 | A | A | A | A | A | A | B | A | Ex. 18 |
| 19 | A | A | A | A | A | A | B | A | Ex. 19 |
| 20 | A | A | A | A | A | A | B | A | Ex. 20 |
| 21 | A | A | A | A | A | A | B | A | Ex. 21 |
| 22 | A | A | A | A | A | A | B | A | Ex. 22 |
| 23 | B | A | B | A | A | B | B | A | Ex. 23 |
| 24 | A | B | A | A | B | A | A | B | Ex. 24 |
| 25 | A | A | A | A | A | A | A | A | Ex. 25 |
| 26 | A | A | A | A | A | A | A | A | Ex. 26 |
| 27 | A | A | A | A | A | A | A | A | Ex. 27 |
| 28 | A | A | A | A | A | A | A | A | Ex. 28 |
| 29 | A | A | A | A | A | A | B | A | Ex. 29 |
| 30 | A | A | A | A | A | A | B | A | Ex. 30 |
| 31 | A | A | A | A | A | A | B | A | Ex. 31 |
| 32 | A | A | A | A | A | A | B | A | Ex. 32 |
| 33 | A | A | A | A | A | A | B | A | Ex. 33 |
| 34 | A | A | A | A | A | A | B | A | Ex. 34 |
| 35 | D | D | D | A | A | A | A | D | Comp. Ex. 1 |
| 36 | D | D | D | A | A | A | A | A | Comp. Ex. 2 |
| 37 | D | D | D | A | A | A | A | A | Comp. Ex. 3 |
| 38 | A | A | A | D | A | A | A | A | Comp. Ex. 4 |
| 39 | C | A | A | A | A | A | A | A | Comp. Ex. 5 |
| 40 | A | D | D | A | A | A | A | A | Comp. Ex. 6 |
| 41 | C | C | C | A | A | A | A | A | Comp. Ex. 7 |
| 42 | A | A | A | C | A | A | A | A | Comp. Ex. 8 |
| 43 | A | A | A | A | A | A | A | A | Ex. 35 |
| 44 | A | A | A | A | A | A | B | A | Ex. 36 |
| 45 | A | A | A | A | A | A | A | A | Ex. 37 |
| 46 | A | A | A | A | A | A | A | A | Ex. 38 |
| 47 | A | A | A | A | A | A | A | A | Ex. 39 |

TABLE 3

| Symbol | Name | Chemical formula | Maker | Trade name |
|---|---|---|---|---|
| Z1 | Ammonium zirconium | (NH₄)₂{Zr(CO₃)₂(OH)₂)} | Daiichi Kigenso | Zircosol AC-20 |
| | carbonate | | Kagagu | |
| Z2 | Potassium zirconium | K₂{Zr(CO₃)₂(OH)₂)} | Nippon Light Metal | Zirmel 1000 |
| | carbonate | | | |
| Z3 | Zirconium acetate | (CH₃CO₂)nZr | Daiichi Kigenso | Zircosol ZA-20 |
| | | | Kagagu | |
| Z4 | Zirconium sulfate | H₂Zr(OH)₂(SO₄)₂ | Nippon Light Metal | — |
| Z5 | Zirconium nitrate | ZrO(NO₃)₂ | Nippon Light Metal | — |
| Z6 | Potassium | K₂ZrF₆ | Mitsubishi Material | — |
| | fluorozirconate | | Electronic Chemicals | |

TABLE 4

| Symbol | Name | Chemical formula |
|---|---|---|
| B1 | Boric acid | H₃BO₃ |
| B2 | Sodium metaborate | NaBO₂ |

TABLE 5

| Symbol | Maker | Classification | Trade name |
|---|---|---|---|
| S1 | Nissan Chemical Industries | Colloidal silica | SNOWTEX O |
| S2 | Nissan Chemical Industries | Colloidal silica | SNOWTEX N |
| S3 | Nissan Chemical Industries | Colloidal silica | SNOWTEX C |
| S4 | Evonik Degussa Japan | Fumed silica | AEROSIL200 |

TABLE 6

| Symbol | Name | Chemical formula |
|---|---|---|
| P1 | Phosphoric acid | H₃PO₄ |
| P2 | Ammonium phosphate | (NH₄)₃PO₄ |
| N1 | Nickel nitrate | Ni(NO₃)₂•6H₂O |
| N2 | Zirconium nitrate | ZrO(NO₃)₂ |

TABLE 7

| Symbol | Name | Maker | Trade name |
|---|---|---|---|
| R1 | Epoxy resin | DIC | — |
| R2 | Polyester resin | Toyobo | Vylonal MD1200 |
| R3 | Acrylic resin | DIC | VONCOAT CP6140 |
| R4 | Urethane resin | ADEKA | ADEKA BONTIGHTER HUX |

TABLE 8

| Symbol | Name |
|---|---|
| CI1 | N-2-(aminoethyl)-3-aminopropyltrimethoxysilane |
| CI2 | 3-Aminopropyltrimethoxysilane |
| CI3 | 3-Glycidoxypropyltrimethoxysilane |

As shown in Table 2, all of the electrical steel sheets provided with our insulating coating which has inorganic with some organic materials obtained are excellent in terms of corrosion resistance and powdering resistance, also excellent in terms of scratch resistance after stress relief annealing, sticking resistance, punchability, TIG weldability, and water resistance and, furthermore, excellent in terms of the appearance after stress relief annealing.

In contrast, in Comparative Examples 1 and 2 in which the amount of the Zr compound is out of the proper range, the corrosion resistance, powdering resistance, and scratch resistance after annealing are poor. In particular, in Comparative Example 1, the appearance after annealing is also poor. In addition, it has been confirmed that in the case where the Zr compound is not added, characteristics similar to those in Comparative Example 1 only are obtained.

Furthermore, in Comparative Examples 3 and 7 in which the amount of the B compound is less than the lower limit, the corrosion resistance, powdering resistance, and scratch resistance after annealing are poor. On the other hand, in Comparative Examples 4 and 8 in which the amount of the B compound exceeds the upper limit, the sticking property is poor. In addition, we confirmed that in the case where the B compound is not added, characteristics similar to those in Comparative Example 3 only are obtained.

In Comparative Example 5 in which the amount of the Si compound is less than the lower limit, the corrosion resistance is poor. On the other hand, in Comparative Example 6 in which the amount of the Si compound exceeds the upper limit, the powdering resistance and scratch resistance after annealing are poor. In addition, we confirmed that in the case where the Si compound is not added, characteristics similar to those in Comparative Example 5 only are obtained.

Furthermore, the same examination was performed on electrical steel sheets other than those described above [e.g., 50A1000 (JIS C 2552(2000)): non-oriented, W_{15/50}≦10.00 W/kg, B₅₀≦1.69T, major composition: about 30 ppm of C, about 0.25% by mass of Si, about 0.25% by mass of Mn, about 0.25% by mass of Al, and about 0.080% by mass of P], and the similar results were obtained.

### INDUSTRIAL APPLICABILITY

The electrical steel sheet provided with our insulating coating which has inorganic with some organic materials has excellent characteristics such as powdering resistance, scratch resistance, sticking property, TIG weldability, and punchability. Furthermore, in the electrical steel sheet provided with our insulating coating which has inorganic with some organic materials, water resistance and corrosion resistance do not degrade even when not containing a chromium compound. Furthermore, the electrical steel sheet provided with our insulating coating which has inorganic with some organic materials is also excellent in terms of uniformity in the appearance of the coating after annealing. Consequently, the electrical steel sheet provided with our insulating coating which has inorganic with some organic materials has no environmental load and can meet high material requirements in the recent industry.

1. An electrical steel sheet provided with an insulating coating which has inorganic with some organic materials, the insulating coating being disposed on a surface of the electrical steel sheet and comprising inorganic components and an organic resin, wherein the insulating coating comprises, as the inorganic components, a Zr compound, a B compound, and a Si compound, when expressed as percentages in the dry coating, 20% to 70% by mass of the Zr compound (in terms of ZrO₂), 0.1% to 5% by mass of the B compound (in terms of B₂O₃), and 10% to 50% by mass of the Si compound (in terms of SiO₂), and the balance containing the organic resin.

2. The electrical steel sheet according to claim 1, wherein the coating further comprises, when expressed as a percentage in the dry coating, 30% by mass or less of one or two or more selected from the group consisting of a nitric compound (in terms of NO₃), a silane coupling agent (in terms of solid content), and a phosphorus compound (in terms of P₂O₅).

3. The electrical steel sheet according to claim 1, wherein content of the organic resin in the coating is 5% to 40% by mass, when expressed as a percentage in the dry coating.

4. The electrical steel sheet according to claim 1, wherein content of the organic resin in the coating is 5% to 40% by mass, when expressed as a percentage in the dry coating.
